(19) United States
(12) Patent Application Publication
(10) Pub. No.: US 2013/0020842 A1
(43) Pub. Date: Jan. 24, 2013

(54) PIEZOELECTRIC MODULE AND SEAT FOR VEHICLE INCLUDING THE SAME

(71) Applicants: Ju Hwan Yang, Gyeonggi-do (KR); Dong Hyeok Choi, Gyeonggi-do (KR); Boum Seock Kim, Gyeonggi-do (KR); Sung Kwon Wi, Seoul (KR); Sung Ho Lee, Gyeonggi-do (KR)

(72) Inventors: Ju Hwan Yang, Gyeonggi-do (KR); Dong Hyeok Choi, Gyeonggi-do (KR); Boum Seock Kim, Gyeonggi-do (KR); Sung Kwon Wi, Seoul (KR); Sung Ho Lee, Gyeonggi-do (KR)

(73) Assignee: SAMSUNG ELECTRO-MECHANICS CO., LTD.S, Suwon (KR)

(21) Appl. No.: 13/489,787

(22) Filed: Jun. 6, 2012

(30) Foreign Application Priority Data
Jul. 19, 2011 (KR) 10-2011-0071532

(51) Int. Cl. B60H 1/22; B60N 2/56

(52) U.S. Cl. 297/180.12; 219/210

(57) ABSTRACT

Disclosed herein are a piezoelectric module and a sheet for a vehicle including the same. The sheet includes: a seat board part supporting a passenger's lower body; a backplate part formed to be extended in a direction perpendicular to one side of the seat board part and supporting the passenger's upper body; and a piezoelectric module formed in the seat board part and generating warm air or cold air using a flow of a current generated by vehicle vibration to thereby transfer the generated warm air or cold air to the passenger's body.

### CROSS REFERENCE(S) TO RELATED APPLICATIONS

This application claims the benefit under 35 U.S.C. Section 119 of Korean Patent Application Serial No. 10-2011-0071532, entitled “Piezoelectric Module And Seat For Vehicle Including The Same” filed on Jul. 19, 2011, which is hereby incorporated by reference in its entirety into this application.

### BACKGROUND OF THE INVENTION

1. Technical Field

The present invention relates to a piezoelectric module and a seat for a vehicle including the same, and more particularly, to a piezoelectric module capable of being heated and cooled, and a seat for a vehicle including the same.

2. Description of the Related Art

Generally, a heat wire is installed in an inner portion of a seat for a vehicle to increase a temperature of the seat, thereby making it possible to allow a passenger to sit on the seat at a pleasant temperature.

When the heat wire has a power applied thereto, it generates resistance heat by electrical resistance, thereby heating the seat.

The above-mentioned technical configuration, which is a background technology for helping to understand the present invention, does not mean the related art well known in the art to which the present invention pertains.

### SUMMARY OF THE INVENTION

An object of the present invention is to provide a piezoelectric module for designing an environment-friendly concept vehicle by reducing an electrical energy and a carbon energy, and a seat for a vehicle including the same.

According to an exemplary embodiment of the present invention, there is provided a sheet for a vehicle, the sheet including: a seat board part supporting a passenger's lower body; a backplate part formed to be extended in a direction perpendicular to one side of the seat board part and supporting the passenger's upper body; and a piezoelectric module formed in the seat board part and generating warm air or cold air using a flow of a current generated by vehicle vibration to thereby transfer the generated warm air or cold air to the passenger's body.

According to another exemplary embodiment of the present invention, there is provided a piezoelectric module including: a vibration sensing unit sensing vehicle vibration; a piezoelectric unit converting an electrical energy generated by the vehicle vibration received from the vibration sensing unit into an AC voltage; a converting unit converting the AC voltage received from the piezoelectric unit into a DC voltage and storing the converted DC voltage therein; and a thermoelectric unit generating warm air or cold air in response to the DC voltage stored in the converting unit and transferring the generated warm air or cold air to a passenger's body.

### BRIEF DESCRIPTION OF THE DRAWINGS

FIG. 1 is a view showing a seat for a vehicle including a piezoelectric module according to an exemplary embodiment of the present invention;

FIG. 2 is a detailed view showing the piezoelectric module of FIG. 1; and

FIG. 3 is a detailed view showing the thermoelectric unit of FIG. 2.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, a piezoelectric module and a seat for a vehicle including the same according to exemplary embodiments of the present invention will be described with reference to the accompanying drawings.

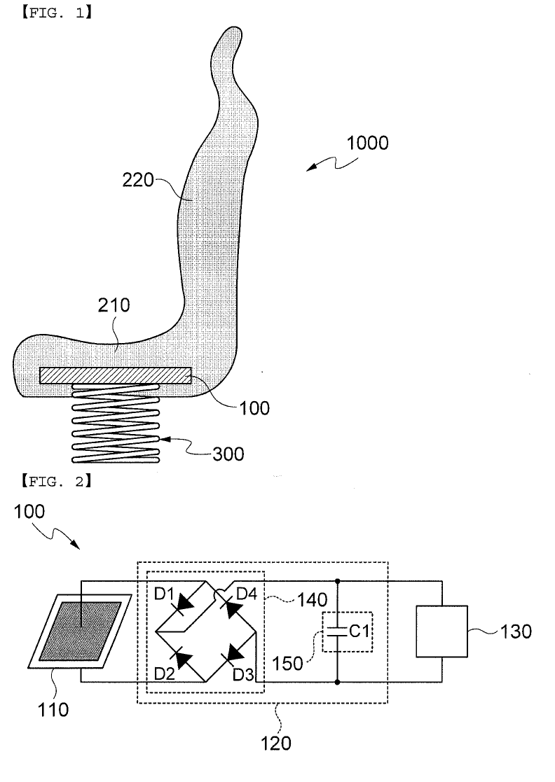

FIG. 1 is a view showing a piezoelectric module and a seat for a vehicle including the same according to an exemplary embodiment of the present invention.

As shown in FIG. 1, a seat 1000 for a vehicle according to an exemplary embodiment of the present invention stably supports a weight of a vehicle passenger to thereby absorb vibration and impact generated during a process of driving a vehicle simultaneously with allowing the vehicle passenger to ride in the vehicle in a comfortable posture.

This seat 1000 for a vehicle may be configured to include a seat board part 210 supporting the passenger's lower body and a backplate part 220 formed to be extended in a direction perpendicular to one side of the seat board part 210 and supporting the passenger's upper body.

Here, for example, seat foams (not shown) made of a synthetic resin forming agent, or the like, are inserted into inner portions of covers (not shown) of the seat board part 210 and the backplate part 220 and a frame (not shown) of the seat, a spring (not shown), and the like, are inserted into the seat foams, such that the seat board part 210 and the backplate part 220 may comfortably support the passenger's body.

In addition, a piezoelectric module 100 is provided in the seat board part 210. This piezoelectric module 100, which transfers cold air or warm air directly to the passenger's body, may generate warm air or cold air through a flow of a current generated by vibration generated at the time of driving of the vehicle.

More specifically, the piezoelectric module 100 according to the exemplary embodiment of the present invention may receive the vibration generated during driving of the vehicle from a vibration sensing unit 300 disposed on a rear surface of the seat board part 210 of the seat 1000 for a vehicle.

In addition, the piezoelectric module 100 may convert an electrical energy, that is, an alternate current voltage, generated by the vibration received from the vibration sensing unit 300 to a direct current voltage and transfer the cold air or the warm air directly to the passenger's body through the converted direct current voltage.

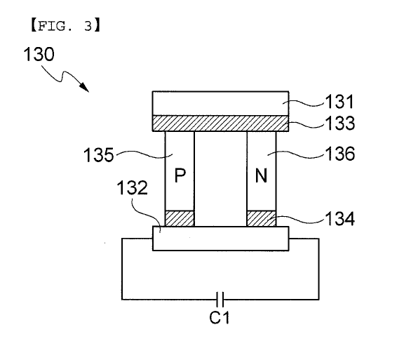

Hereinafter, a detailed description of the piezoelectric module 100 according to the exemplary embodiment of the present invention will be provided with reference to FIG. 2.

As described above, the seat 1000 for a vehicle including the piezoelectric module 100 according to the exemplary embodiment of the present invention drives the piezoelectric module using the electric energy generated by the vibration generated at the time of driving of the vehicle, thereby making it possible to perform coldness and warmth control of the sheet for a vehicle without the supply of a voltage.

In addition, since the seat 1000 for a vehicle including the piezoelectric module 100 uses the energy generated through the vibration energy of the vehicle, it is possible to design an environment-friendly concept vehicle contributing to a reduction in an electrical energy or a carbon energy.

FIG. 2 is a view showing a detailed configuration of the piezoelectric module of FIG. 1.

As shown in FIG. 2, the piezoelectric module 100 includes a piezoelectric unit 110, a converting unit 120, and a thermoelectric unit 130.

The piezoelectric unit 110 may convert the vibration received from the vibration sensing unit 300 (See FIG. 1) into an electrical energy, that is, an alternate current (AC) voltage.

More specifically, the piezoelectric unit 110 receives the vibration from the vibration sensing unit 300 to thereby generate a piezoelectric effect. That is, pressure acts on a piezoelectric crystal, such that the AC voltage is generated on two surfaces facing the piezoelectric crystal.

The converting unit 120 may convert the electrical energy, that is, the AC voltage, received from the piezoelectric unit 110 into a direct current (DC) voltage and store the converted DC voltage.

This converting unit 120 may be configured to include a rectifying unit 140 converting the AC voltage generated in the piezoelectric unit 110 into a DC voltage having a preset magnitude and an electric storage unit 150 storing the converted DC voltage therein to thereby be used as a unit capable of driving the thermoelectric unit 130.

Here, the rectifying unit 140 has, for example, low forward resistance and sufficient high reverse resistance to thereby be able to perform a rectifying operation passing through a current only in one direction and may perform rectification using only one element such as a diode. However, the rectifying unit 140 may be formed of a bridge diode D1 to D4 in order to effectively perform rectification.

In addition, the electric storage unit 150 according to the exemplary embodiment of the present invention may be made of, for example, a supercapacitor C1.

The thermoelectric unit 130 may generate warm air or cold air in response to the DC voltage provided from the converting unit 120 and provide the generated warm air and cold air to the seat for a vehicle.

More specifically, the thermoelectric unit 130 may be formed as, for example, a thermoelectric module as shown in FIG. 3. That is, a P type thermoelectric element 135 and an N type thermoelectric element 136 may be electrically connected to each other by electrodes 133 and 134.

In this thermoelectric unit 130, in response to the DC voltage stored in the electric storage unit 150, heat absorption is generated in an upper substrate 131, and heat radiation is generated in a lower substrate 132. Meanwhile, the heat absorption and the heat radiation are not limited to the above-mentioned exemplary embodiment. That is, positions at which the heat absorption and the heat radiation are generated may be changed according to a direction of a current.

Meanwhile, the thermoelectric unit 130 is formed in plural. The plurality of thermoelectric units 130 may be selectively driven by speed per hour of the vehicle to generate the warm air or the cold air and provide the generated warm air or cold air to the seat for a vehicle.

More specifically, for example, assuming that one vehicle is driven at 1 Km/h, the piezoelectric unit 110 may generate a consumption power amount of, for example, 400 Wh.

In addition, assuming that 100 W of power is consumed when any one of the plurality of thermoelectric units 130 is driven, since the piezoelectric unit 110 may generate a consumption power amount of 400 Wh as described above, when one vehicle is driven at 1 Km/h, a total of four thermoelectric units 130 are driven, thereby making it possible to generate a corresponding heat. Therefore, the number of plurality of thermoelectric units 130 may be four. In addition, the plurality of thermoelectric units 130 may be selectively activated and deactivated by speed per hour of the vehicle.

As described above, the seat 1000 for a vehicle including the piezoelectric module 100 according to the exemplary embodiment of the present invention drives the piezoelectric module using the electric energy by the vibration generated at the time of driving of the vehicle, thereby making it possible to control coldness and warmth of the sheet for a vehicle without the supply of the voltage.

In addition, since the seat 1000 for a vehicle including the piezoelectric module 100 uses the energy generated through the vibration energy of the vehicle, it is possible to design an environment-friendly concept vehicle contributing to a reduction in an electrical energy or a carbon energy.

As set forth above, with piezoelectric module and the seat for a vehicle including the same according to the exemplary embodiments of the present invention, the piezoelectric module is driven using an electrical energy generated by the vibration generated at the time of driving of the vehicle, thereby making it possible to control coldness and warmth of the sheet for a vehicle control without the supply of a voltage.

In addition, since the seat for a vehicle including the piezoelectric module uses the energy generated through the vibration energy of the vehicle, it is possible to design an environment-friendly concept vehicle contributing to a reduction in an electrical energy or a carbon energy.

While the present invention has been shown and described in connection with the embodiments, it will be apparent to those skilled in the art that modifications and variations can be made without departing from the spirit and scope of the invention as defined by the appended claims.

What is claimed is:

1. A sheet for a vehicle, the sheet comprising:
a seat board part supporting a passenger's lower body;
a backplate part formed to be extended in a direction perpendicular to one side of the seat board part and supporting the passenger's upper body; and
a piezoelectric module formed in the seat board part and generating warm air or cold air using a flow of a current generated by vehicle vibration to thereby transfer the generated warm air or cold air to the passenger's body.

2. The sheet according to claim 1, further comprising a vibration sensing unit disposed on a rear surface of the seat board part and transferring the vehicle vibration generated during driving of the vehicle to the piezoelectric module.

3. The sheet according to claim 2, wherein the piezoelectric module includes:
a piezoelectric unit converting an electrical energy generated by the vehicle vibration received from the vibration sensing unit into an alternate current (AC) voltage;
a converting unit converting the AC voltage received from the piezoelectric unit into a direct current (DC) voltage and storing the converted DC voltage therein; and
a thermoelectric unit generating the warm air or the cold air in response to the DC voltage stored in the converting unit.

4. The sheet according to claim 3, wherein the converting unit includes:
a rectifying unit converting the AC voltage generated in the piezoelectric unit into the DC voltage having a preset magnitude; and
an electric storage unit storing the DC voltage converted by the rectifying unit therein.

5. The sheet according to claim 4, wherein the rectifying unit is formed of a bridge diode.

6. The sheet according to claim 4, wherein the electric storage unit is made of a supercapacitor.

7. A piezoelectric module comprising:
a vibration sensing unit sensing vehicle vibration;
a piezoelectric unit converting an electrical energy generated by the vehicle vibration received from the vibration sensing unit into an AC voltage;
a converting unit converting the AC voltage received from the piezoelectric unit into a DC voltage and storing the converted DC voltage therein; and
a thermoelectric unit generating warm air or cold air in response to the DC voltage stored in the converting unit and transferring the generated warm air or cold air to a passenger's body.

8. The piezoelectric module according to claim 7, wherein the converting unit includes:
a rectifying unit converting the AC voltage generated in the piezoelectric unit into the DC voltage having a preset magnitude; and
an electric storage unit storing the DC voltage converted by the rectifying unit therein.

9. The piezoelectric module according to claim 8, wherein the rectifying unit is formed of a bridge diode.

10. The piezoelectric module according to claim 8, wherein the electric storage unit is made of a supercapacitor.
